(19) United States
(12) Patent Application Publication
(10) Pub. No.: US 2008/0093184 A1
(43) Pub. Date: Apr. 24, 2008

(54) Brake disc assembly

(76) Inventor: Andrew Freeman, Northampton (GB)

Correspondence Address: DONN K. HARMS;PATENT & TRADEMARK LAW CENTER, SUITE 100, 12702 VIA CORTINA, DEL MAR, CA, 92014, US

(21) Appl. No.: 11/880,374

(22) Filed: Jul. 19, 2007

(30) Foreign Application Priority Data
Oct. 18, 2006 (GB) 0620717.9

(51) Int. Cl. F16D 65/12

(52) U.S. Cl. 188/218 XL

(57) ABSTRACT

A brake disc rotor assembly formed of a radially inner part adapted for securement to a hub and a radially outer part spaced from the inner part and secured thereto by a plurality of fasteners engaged into apertures formed by opposing U-shaped slots having two parallel sidewalls and an arched wall communicating therebetween. The outer part is adapted for engagement by brake pads to apply a braking force to the formed rotor. The inner and outer parts having adjacent regions to the U-shaped slots which are substantially coplanar.

This application claims priority to United Kingdom Application number 0620717.9 filed Oct. 18, 2006, and incorporated by reference herein. This invention relates to a brake disc assembly comprising a radially inner part which in use is secured to a hub and a radially outer part which in use is engaged by brake pads to retard rotation of the hub. The invention is primarily intended as a brake disc assembly for a vehicle, more particularly for a motorcycle. However, the invention is not limited to such applications and indeed may be applied to a wide range of circumstances in which a brake disc is required.

Historically, brake discs, particularly for automotive applications, have been unitary structures including an inner region that, in use, is secured to the hub of a wheel, and an outer region which is engaged by brake pads. It has, however, been appreciated for some time that such arrangements are unsatisfactory in that the thermal stresses generated by heavy and prolonged braking are not well accommodated by a unitary structure with the result that deformation of the disc is liable to occur be caused by heavy and prolonged braking.

With a view to obviating the problem outlined above it has been proposed to form a disc brake assembly of two separately formed components that are interconnected to form the complete assembly. The two components comprise a radially inner part that, in use, is secured to the wheel hub and a radially outer part that, in use, is engaged by the brake pads. The radially inner and outer parts are interconnected in a manner which permits torque to be transmitted therebetween but which permits expansion of the outer part in the radial direction as a result of heating. An arrangement of this type is shown in U.S. Pat. No. 3,542,166.

Such systems of the prior art have tended to be of substantial and robust construction resulting in a structure requiring extensive machining during manufacture and which in its final form is of substantial mass. Such arrangements have accordingly been expensive and not suited to relatively low cost lightweight applications such as, for example, the disc brakes of motorcycles.

It is also known to fabricate brake disc assemblies for use on motorcycles from separate radially inner and radially outer components that are secured together by buttons. In the zone of the buttons the radially inner and radially outer components are co-planar and each of the radially inner and radially outer components is formed, in the zone of each button, with a substantially semi circular recess. The buttons are circular in transverse cross section and are designed to be a tight fit relative to the recesses. With such an arrangement, if the outer component expands in the radial direction as a result of heating during prolonged braking the respective recesses on the inner and outer components will move away from each other and as a result of the circular cross section of the buttons some relative circumferential movement between the inner and outer components will become possible. Since any excess slack between the inner and outer components could give rise to vibration and unsafe conditions the components are designed to close tolerances and at normal ambient temperate temperatures the buttons are in fact compressed between the inner and outer components. As a result, the prior brake disc assemblies are not well able to cope with excessively high braking temperatures as may be experienced, for example during a prolonged mountain descent and, at the same time, are liable to distortion if exposed to excessively cold conditions, for example external night temperatures in cold regions. Further, the use of circular buttons means that as soon as any radial pre-load applied to the buttons has been released by some expansion of the outer component, drive contact (in the circumferential direction) between the inner component and each button on the one hand, and between the outer component and each button on the other hand will be essentially point contact. Such point contact is subject to where with the result that the buttons become loose within the recesses and vibration occurs.

We have now devised a brake disc assembly which overcomes the disadvantages of the prior art and provides a relatively low cost and lightweight structure particularly suitable for use on motorcycles.

According to one aspect of the present invention there is provided a brake disc assembly comprising: a radially inner part that in use is secured to a hub; a radially outer part that in use is engaged by brake pads to apply a braking force to the hub, the inner and outer parts having adjacent regions that are substantially coplanar; and a plurality of fasteners interconnecting the inner and outer parts, each fastener being located in said coplanar region and working in a slot defined by the inner and outer parts, each fastener being a close fit in its respective slot in the circumferential direction whereby in use the outer part is able to expand in the radial direction relative to the inner part in response at elevated temperature.

In the preferred embodiment of the invention the inner and outer parts are coplanar throughout their entire extent. Such components can readily be made from plate material at relatively low cost.

Preferably, the slots are formed by opposing substantially U-shaped cut-outs in the inner periphery of the outer part and the outer periphery of the inner part.

Preferably, the fasteners include a pair of substantially parallel walls which are spaced apart to be a close working fit in their respective slot. Preferably, the fasteners are in the form of hollow fasteners that, after positioning, are rolled over on at least one end thereof to prevent removal.

The use of parallel walls on the fastener which are a close working fit in their respective slot at ambient temperature ensures that, upon a radial expansion of the outer part as a result of heating, there will still be line contact between the outer part and each fastener on the one hand, and between each fastener and the inner part on the other hand. This contrasts with the point contact which resulted from the use of circular fasteners in the prior art. The line content is not only well able to transfer the required forces, but is also not subject to the wear that was associated with point contact of the prior art. Also, the progressive radial expansion of the outer part will not result in a progressive increase in circumferential backlash in a manner that was inherent in the circular fastenings of the prior art. Accordingly, the use of fasteners with parallel walls not only reduces the slackness that was inherent in prior art devices, even when new, but also reduces the increased slackness which prior art designs were subject as a result of rapid wear at the point contact positions.

In a particularly preferred embodiment of the invention each fastener comprises one flange located adjacent one face of the inner and outer parts of the assembly and second flange located on the other face of the inner and outer parts of the assembly. Preferably, one of the flanges is provided by a washer that is retained in position by a deformed portion of the fastener. Preferably, a spring washer, for example a wavy washer, is located between at least one of the flanges and the adjacent inner and outer parts.

The use of wavy washers ensures precise control of the position of the inner part relative to the outer part in the axial direction. In the prior art, where no wavy washers or equivalent components were provided, wear of the fasteners would result in axial freedom of movement or the outer part relative to the inner part. Although the axial movement was small it could in the prior art result in brake pads being pushed apart somewhat more than their design distance when brakes were released. This problem was particularly acute if deformation of the outer part as a result of previous distortion was present. Pushing the brake pads further apart than their intended running distance has the result of pushing brake fluid back into the system reservoir with the result that when the brakes are next applied there is excessive travel in the brake lever. In extreme cases the available travel of the brake lever will be insufficient to apply the brakes fully with the result that either the rider is faced with inadequate brake force or he must “pump” the brake lever to displace sufficient brake fluid to take up the excess clearance. The present invention, by substantially eliminating distortion of the outer part and control accurately the position of the outer part relative to the inner part (when measured in the axial direction) substantially eliminates this problem.

In accordance with a second aspect of the present invention a brake disc assembly comprises a radially inner part that is in use secured to a hub, a radially outer part that is in use engaged by brake pads to apply a braking force to the hub, and a plurality of fasteners interconnecting the inner and outer parts, each fastener working in a slot defined in one or both of the inner and outer parts, the fastener being a close fit in the slot in the circumferential direction and a clearance fit in the slot in the radial direction whereby in use the outer part is able to expand in the radial direction relative to the inner part in response to elevated temperature.

The invention will be better understood from the following description of a preferred embodiment thereof, given by way of example only, reference being had to the accompanying drawings wherein:

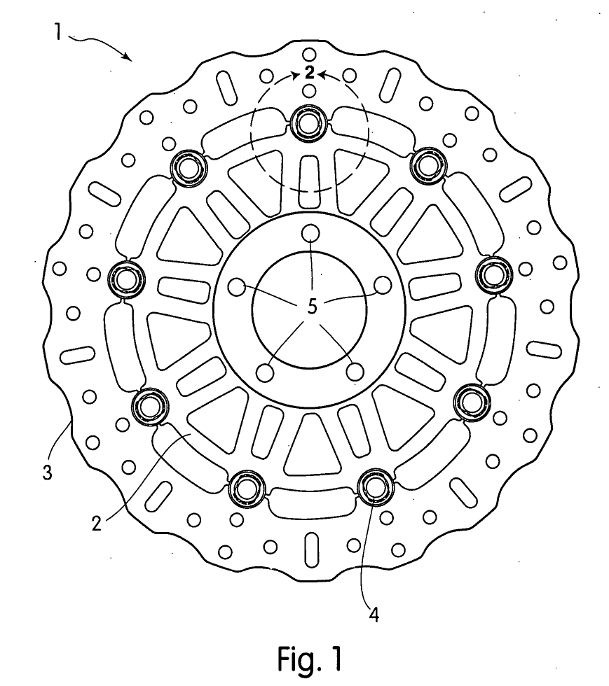

FIG. 1 illustrates a brake disc assembly in accordance with a preferred embodiment of the invention;

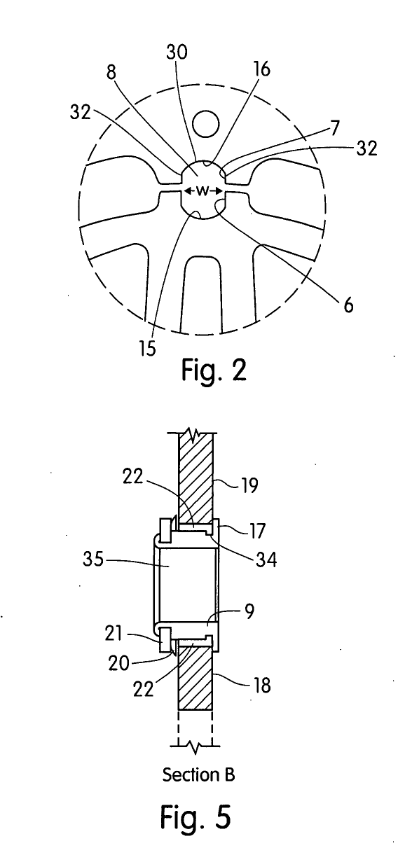

FIG. 2 shows on a larger scale the structure of the radially inner and outer parts of the assembly of FIG. 1 in the region of the detail circled by broken line in FIG. 1;

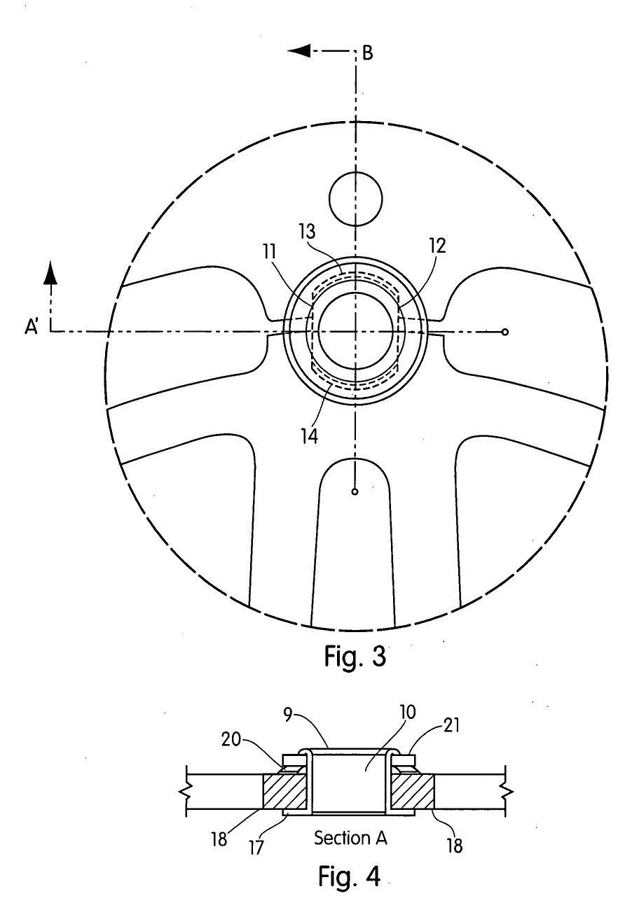

FIG. 3 is a view on a yet larger scale illustrating the assembly of FIG. 1 in the region of the detail circled by broken line on FIG. 1;

FIG. 4 is a section on the line A of FIG. 3; and

FIG. 5 is a section on the line B of FIG. 3.

Referring firstly to FIG. 1 the illustrated brake disc assembly 1 comprises a radially inner part 2 and a radially outer part 3 interconnected by a plurality of fasteners 4. In the illustrated embodiment of the invention nine fasteners are use to interconnect the inner and outer parts, but the actual number of fasteners may be more or less than this depending on the size and load bearing requirements for the disc assembly.

The inner 2 and outer 3 parts are preferably of substantially uniform thickness, measured in the axial direction, throughout. Such parts can conveniently be formed from plate material by, for example, laser cutting from plate material. Little if any post-forming finishing will be required for such components and accordingly they can be produced at relatively low cost. The materials from which the inner and outer parts are formed may be the same material or the respective parts may be formed from different materials selected to optimize the respective characteristics required for the inner and outer parts.

In use, the inner part 2 is secured to a wheel hub by means of bolts or studs passing through holes 5 provided for the purpose in the inner part. In use the outer part is engaged by the brake pads of one or more brake callipers in conventional manner.

The inner and outer parts are coplanar, at least in their mutually adjacent regions. In such regions, one of which is illustrated in FIG. 2, a cut-out 6 is provided in the inner part and a cut-out 7 is provided in the outer part. The cut-outs have an equal width W measured in the circumferential direction and together form an arched slot 8 in which the associated fastener 4 works. The structure of the fasteners is shown in greater detail in FIGS. 3-5. Each fastener comprises a tubular button 9 which is formed from any suitable material, for example mild steel. Each fastening includes a through passage 10 which is circular in transverse cross-section. The exterior profile of the buttons, in the zone of the inner and outer parts, comprises parallel walls 11, 12 interconnected by part circular end walls 13, 14. The mutual spacing of the parallel walls 11,12 is a close working fit relative to the width W of the arched slot 8. The mutual spacing of the part-circular walls 13, 14 is a clearance fit relative to the end walls 15, 16 of the arched slot 8 when the inner and outer parts of the assembly are both at temperate ambient temperature.

To assemble the components described above the inner and outer parts 2, 3 are offered up to each other and the buttons 9 inserted into the slots 8 formed of an arched wall 30 between two parallel straight walls 32 on each side of the arched wall 30 so that an end flange 17 of each button along the straight wall 32 at each end of the respective arches of the slot 8, engage corresponding faces 18 and 19 of the inner and outer parts respectively. It is important that the notch or recess 34 shown in FIG. 5, be placed adjacent to the end flange 17 to insure that full contact of the face of the end flange 17 with the faces 18 and 19 of the inner and outer parts as this increases the face area of the flange 17 and provides a means to eliminate the potential for a chamfer in the corner area of the flange 17 and the tubular part 35 of the button 9 causing inaccurate alignment of the inner and outer parts of the formed rotor. Further, it has been found that the arched wall 32 communicating between the straight walls 32 provides a stronger support and better thermal expansion and contraction qualities than a simple linear engagement of the straight walls 32.

A spring washer 20, for example a stainless steel wavy washer, and a retaining washer 21, is then placed over the tubular part 35 of each button 9 and the projecting end of the button 9 is rolled outwardly to retain the washer 21 in position as illustrated particularly in FIGS. 4 and 5. A recess 34 is not required adjacent to the washer 21 since there is no possibility of a chamfer at its intersection with the tubular part 35 as with the machined end flange 17. Such an arrangement provides a low cost, reliable and robust means of assembling the components of the complete brake disc assembly which when formed of the inner and outer parts and held by the button 9 will runs true on the hub.

Further, although the assembly technique outlined above can readily be accomplished under factory conditions, it cannot be replicated easily without specialist machinery. Accordingly, the complete assembly, once formed, is substantially tamper-proof in that although the buttons could readily be removed by drilling, it would not then be possible to reassemble the inner and outer parts without the necessary specialist machinery.

In use, the close-fit in the circumferential direction between the parallel walls 11,12 of each button and the corresponding walls of each slot 8 ensures precise location of the outer part relative to the inner part. However, when the outer part is heated as a result of braking it is free to increase in diameter and, by virtue of the spring washer 20 in thickness, without distortion. In practice, at normal temperate ambient temperatures (say about 20° C.) a small clearance 22 will exist in the radial direction between each of the button walls 13, 14 and the corresponding slot wall 16, 15. If the brake assembly is subjected to excessively cold conditions (as a result, for example, of being left out of doors on a vehicle on a cold winter's night) the outer part can contract relatively to the inner part without deformation by taking up some of the radial clearance 22 and the recess 34 prevents any interference from the corner machining of the end flange 17 and tubular part 35 which are machined of a unitary structure as shown in FIG. 5. Similarly, if the outer part becomes heated, the outer part is free to expand by increasing the radial clearance 22. Accurate location and full torque transmission between the respective parts will, however, be maintained by the parallel walls 11,12 of the buttons.

A further advantage of the present invention is that there is relatively little thermal conduction between the inner and outer parts of the assembly because such conduction can only occur via the fasteners since there is a gap running in between the inner and outer parts elsewhere thereby providing means to reduce thermal conduction from the outer part to the inner part. Providing adequate means are provided for cooling the outer part in use, the low level at which heat can be transferred from the outer part to the inner part is an advantage in that it will prevent excessive heating of the inner part and, as a result, avoid potential damaging heat being transferred to the hub of the wheel.

The brake disc assembly shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described, may be employed for providing such a device within the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A brake disc assembly comprising:
a radially inner part that in use is secured to a hub;
a radially outer part that in use is engaged by brake pads to apply a braking force to the hub, the inner and outer parts having adjacent regions that are substantially coplanar; and
a plurality of fasteners interconnecting the inner and outer parts, each fastener being located in said coplanar region and working in a slot defined by the inner and outer parts, each fastener being a close fit in its respective slot in the circumferential direction whereby in use the outer part is able to expand in the radial direction relative to the inner part in response at elevated temperature.

2. A brake disc assembly according to claim 1 wherein the inner and outer parts are substantially coplanar throughout their entire extent.

3. A brake disc assembly according to claim 2 wherein at least one of the inner and outer parts is formed from plate material.

4. A brake disc assembly according to claim 1 wherein the slots are formed by opposing substantially U-shaped cut-outs in the inner periphery of the outer part and the outer periphery of the inner part respectively.

5. A brake disc assembly according to claim 1 wherein the fasteners each include a pair of substantially parallel walls which are spaced apart to be a close working fit in their respective slots.

6. A brake disc assembly according to claim 1 wherein the fasteners are hollow fasteners that, after positioning, are rolled over on at least one end thereof to prevent removal.

7. A brake disc assembly according to claim 1 where each fastener comprises a flange that engages one face of the inner and outer parts of the assembly and a second flange located on the other face of the inner and outer parts of the assembly.

8. A brake disc assembly according to claim 7 wherein one of the flanges is provided by a washer which is retained in position by a deformed portion of the fastener.

9. A brake disc assembly according to claim 7 wherein a spring washer is located between at least one of the flanges and the adjacent inner and outer parts.

10. A brake disc assembly according to claim 1 wherein there is no direct contact between the inner part and the outer part.

11. A brake disc assembly according to claim 1 wherein the only route by which heat may be conducted from the outer part to the inner part is via the fasteners.

12. A brake disc assembly according to claim 8 wherein the other said flange is formed as part of a first end of a tubular component of said fastener and said deformed portion of said fastener is located at a second end of said tubular component, opposite said first end.

13. A brake disc assembly according to claim 12 additionally comprising a recess formed in said tubular portion immediately adjacent to said other said flange.

14. A brake disc assembly according to claim 4 where each fastener comprises a flange that engages one face of the inner and outer parts of the assembly and a second flange located on the other face of the inner and outer parts of the assembly.

15. A brake disc assembly according to claim 14 wherein one of the flanges is provided by a washer which is retained in position by a deformed portion of the fastener.

16. A brake disc assembly according to claim 15 wherein the other said flange is formed as part of a first end of a tubular component of said fastener and said deformed portion of said fastener is located at a second end of said tubular component, opposite said first end.

17. A brake disc assembly according to claim 16 additionally comprising a recess formed in said tubular portion immediately adjacent to said other said flange.
